(19) United States
(12) Patent Application Publication
(10) Pub. No.: US 2022/0312819 A1
(43) Pub. Date: Oct. 6, 2022

(54) ENHANCED MECHANISMS AND METHODS FOR OPENING COCONUTS

(71) Applicant: Xiaoran Wang, McKinney, TX (US)

(72) Inventor: Xiaoran Wang, McKinney, TX (US)

(21) Appl. No.: 17/709,379

(22) Filed: Mar. 30, 2022

Related U.S. Application Data
(60) Provisional application No. 63/285,087, filed on Dec. 1, 2021.
(60) Provisional application No. 63/169,018, filed on Mar. 31, 2021.

(51) Int. Cl. A23N 1/00; A47J 19/02

(52) U.S. Cl. CPC A23N 1/00; A47J 19/02

(57) ABSTRACT

Devices, systems, and methods are provided for opening a coconut. A coconut opening device or system may include a piercing component to pierce a coconut; an adjustable component to move the piercing component vertically with respect to the ground toward and away from a coconut based on a received user input; and a coconut holding component arranged below the piercing component to secure the coconut while the coconut is pierced by the piercing component.

### CROSS-REFERENCE TO RELATED APPLICATIONS

This application claims the benefit of U.S. Provisional Application No. 63/285,087, filed Dec. 1, 2021, and of U.S. Provisional Application 63/169,018, filed Mar. 31, 2021, the disclosures of which are incorporated by reference as if set forth in full.

### TECHNICAL FIELD

This disclosure relates to methods, systems, and devices for opening coconuts.

### BACKGROUND

People have been consuming coconuts and coconut water for a long time, and it is estimated that people are consuming between 50-100 billion coconuts annually. However, existing tools to open a coconut may not be convenient or safe for everyone.

### BRIEF DESCRIPTION OF THE DRAWINGS

FIG. 1 illustrates an example side view of a schematic of a coconut opening system, in accordance with one or more example embodiments of the present disclosure.

FIG. 2 illustrates an example perspective view of a coconut opening system, in accordance with one or more example embodiments of the present disclosure.

FIG. 3 illustrates an example perspective view of a portion of the coconut opening system of FIG. 2, in accordance with one or more example embodiments of the present disclosure.

FIG. 4 illustrates an example perspective view of a portion of the coconut opening system of FIG. 2, in accordance with one or more example embodiments of the present disclosure.

FIG. 5 illustrates an example front view of a coconut opening system, in accordance with one or more example embodiments of the present disclosure.

FIG. 6 illustrates an example front view of the coconut opening system of FIG. 5, in accordance with one or more example embodiments of the present disclosure.

FIG. 7 illustrates an example perspective view of the coconut opening system of FIG. 5, in accordance with one or more example embodiments of the present disclosure.

FIG. 8 illustrates an example top view of the coconut opening system of FIG. 5, in accordance with one or more example embodiments of the present disclosure.

FIG. 9 illustrates an example perspective view of a portion of the coconut opening system of FIG. 5, in accordance with one or more example embodiments of the present disclosure.

FIG. 10 illustrates an example perspective view of a portion of the coconut opening system of FIG. 5, in accordance with one or more example embodiments of the present disclosure.

FIG. 11 illustrates an example perspective view of a portion of the coconut opening system of FIG. 5, in accordance with one or more example embodiments of the present disclosure.

FIG. 12 illustrates an example side view of a schematic of a coconut opening system, in accordance with one or more example embodiments of the present disclosure.

FIG. 13 illustrates an example side view of the coconut opening system of FIG. 12, in accordance with one or more example embodiments of the present disclosure.

FIG. 14 illustrates an example perspective view of the coconut opening system of FIG. 12, in accordance with one or more example embodiments of the present disclosure.

FIG. 15 illustrates an example side view of the coconut opening system of FIG. 12, in accordance with one or more example embodiments of the present disclosure.

FIG. 16 illustrates an example front view of the coconut opening system of FIG. 12, in accordance with one or more example embodiments of the present disclosure.

FIG. 17 illustrates an example rear view of the coconut opening system of FIG. 12, in accordance with one or more example embodiments of the present disclosure.

FIG. 18 illustrates an example front view of a portion of the coconut opening system of FIG. 12, in accordance with one or more example embodiments of the present disclosure.

FIG. 19 illustrates an example perspective view of the coconut opening system of FIG. 12, in accordance with one or more example embodiments of the present disclosure.

FIG. 20 illustrates an example front view of a portion of the coconut opening system of FIG. 12, in accordance with one or more example embodiments of the present disclosure.

FIG. 21 illustrates an example front view of the coconut opening system of FIG. 12, in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

### Overview

Example embodiments described herein provide certain systems, methods, and devices for using portable food devices and methods for opening coconuts.

Coconut water may be considered the best natural beverage due to its vitamins, minerals, and electrolytes. However, coconuts can be difficult to open (e.g., for accessing coconut water). For example, some existing tools for opening coconuts effectively represent nails, knives, and hammers, and require manual operation and significant strength. In addition, some existing tools for opening coconuts can carry risk, such as a blade slipping and cutting the person attempting to open the coconut.

There is therefore a need for enhanced mechanisms for opening coconuts.

In one or more embodiments, enhanced coconut openers may be manual (e.g., requiring human operation) or automatic (e.g., using a machine to open the coconut), and may penetrate a coconut in a matter of seconds (e.g., 1-3 seconds, or less for the automatic opener). For example, the time needed for the drill to move down and move up back to its original position may take about six seconds, or say 5-8 seconds, while the downward motion may take about three seconds, or 3-4 seconds, to drill through the coconut shell. An automatic coconut opener may include a moveable apparatus with a drill that may be lowered from a position above a coconut to the coconut (e.g., along a vertical axis perpendicular to the ground), allowing the drill to penetrate and open the coconut without requiring a human operator to manually hold and force the drill into the coconut. The automatic coconut opener may operate using a power supply (e.g., a battery or power receptacle connection), and may be controlled by one or more buttons (e.g., to turn on the automatic coconut opener, to raise/lower the drill, to control drill bit rotation, etc.). In some embodiments, a single button push may cause the drill to rotate a drill bit, and to lower from above the coconut to the surface of the coconut, then continue a downward force allowing the drill bit to penetrate the coconut. Once the drill has penetrated the coconut (e.g., dropped a certain distance from a starting position), the automatic coconut opener may raise the drill and stop rotation of the drill bit.

In one or more embodiments, the automatic coconut opener may include multiple motors (e.g., 12 volt worm motors or the like) that may operate at same or different rotations, such as one motor at 470 rpm and another motor at 60 rpm (or other revolutions per minute). For example, the 60 rpm motor may be used to move the 470 rpm motor and corresponding drill bit up and down (e.g., using a wheel-and-axel-and-leverage-combined system). Using this example, the 60 rpm motor may produce a torque of 40 Ncm, and the wheel-and-axel-and-leverage-combined system may magnify the torque by 20× to 30× (e.g., depending on the friction and property of material, assembly errors, and other operating errors and environmental factors). Alone, the wheel-and-axel system may magnify torque by 10× to 15×, and the leverage portion itself may decrease torque by 1.2× to 2×, and may increase vertical travel distance by 1.5×. The overall wheel-and-axel-and-leverage-combined system may magnify torque to a 700-1000 Newton force, strong enough to penetrate the coconut shell. In one or more embodiments, the manual coconut opener may be safe for use, even by children. The manual coconut opener may use physical human operator power—a push down by the hand, arm, leg, and/or foot. The manual coconut opener may include a handlebar, similar to a stapler, that is intuitive to use. For example, the user may need to secure the coconut (e.g., using a slot/basin of a coconut holding system for securing the coconut), and to push a nail of the manual coconut opener into the coconut shell. The nail may penetrate the coconut shell due to human operator force, and then move up automatically.

In one or more embodiments, the manual coconut opener may include a handlebar as a leverage mechanism. The handlebar can magnify the operator's push-down power (e.g., by 5× the human force applied). For example, a human adult may push down about 80 pounds, and a child may push down around 50-80 pounds, and the force at the nail point of the manual coconut opener may be 5× the applied human force (e.g., 250-400 pounds), enough to penetrate the coconut shell.

In one or more embodiments, the manual and automatic coconut openers may have a coconut holding system with which to secure the coconut for penetration. A user may place a coconut in the coconut holding system, which may have a handlebar that may secure the coconut in place during penetration by an opener (e.g., so that the coconut does not slip or fall). The coconut holding system may include a round basin/slot with which to hold the coconut in place, and a flexible cap to protect the nail or drill bit from being touched (e.g., by children). The flexible cap also may provide a decorative effect, and may move up and down to fit different sizes of coconuts. The flexible cap may have an upward-moving length to stop the coconut from moving with the nail or drill bit (e.g., when the manual handle bar or the drill is released from the coconut and moves upward), allowing for safe removal of the nail or drill from the coconut while securing the coconut in place. The coconut holding system may include multiple claims tightened by springs or other mechanisms to firmly hold the coconut in place under a drill bit or for use of the manual coconut opener.

In one or more embodiments, the drill bit for the automatic coconut opener may be made of a titanium or alloy iron, or another material (e.g., titanium or stainless steel 316, stainless steel 304, or other food-grade hard material, etc.), and may have a bottom point of 1-3 millimeters in width/diameter so that the drill bit may penetrate the coconut without causing the coconut to rotate while the drill bit rotates. The automatic coconut opener may repeatedly raise and lower the drill on a same coconut to increase the size of the drilled hole in the coconut through repeated penetrations.

In one or more embodiments, the automatic coconut opener may include a rod rail system with one or more vertical bars that function as rails to guide the drill bit and the motor to move the drill up and down.

In one or more embodiments, the drill system for the automatic coconut opener may include the drill bit, a motor, and a wheel. The drill bit may be a spiral stepper drill capable of drilling through an iron sheet, for example, the wheel may be metal and capable of magnifying the inertial and angular momentum of the drill system while the drill bit rotates.

In one or more embodiments, the automatic coconut opener may include gears operatively connected to one another and/or a motor. For example, a motor may rotate, causing rotation of a gear operatively connected to the motor. The gear operatively connected to the motor may rotate one or more additional gears of a same or different size. One of the rotating gears may operatively connect to the drill system to cause the drill system to raise or lower the drill based on the direction of the rotation of the rotating gears. For example, the drill bit may be rotating, and rotating of the gears in one direction may cause one or more mechanisms connecting the rotating gears to the drill system to apply a force to the drill system that results in the drill system moving the drill downward toward a coconut. In particular, rotation of the gears in one direction may cause the connection mechanisms (e.g., rods) to apply a force to sliding rods that may be connected to rods of the rod rail system. The force may cause the sliding rods to slide upward or downward, depending on the gear rotation direction and corresponding force. As the sliding connected rods slide up or down on vertical rods of the rod rail system, the drill operatively connected to the sliding rods may slide up or down. When rotating gears (e.g., wheels) pull down operatively connected rods, the drill system may be pulled downward as a result. When the rotating gears push the operatively connected rods upward, the drill system may be pushed upward as a result. When the gears rotate repeatedly, the drill system may be moved upward and downward repeatedly as a result.

In one or more embodiments, the manual coconut opener may include a lever above the coconut when the coconut is held in place by the coconut holding system. When a user applies a downward force to the lever, the lever may, via a connection to a drill system, cause the drill system to slide downward, moving the nail downward toward the coconut. In particular, the nail may be connected to a sliding mechanism (e.g., drill system) that may slide up and down on one or more rods of the rod rail system. When the drill system slides downward in response to user force applied to the lever, the drill system may slide downward on one or more vertical rods of the rod rail system, and correspondingly, the nail may move downward due to its connection to the drill system. When the user applies an upward force to the lever, the rotatable connection may cause the drill system to slide upward along the one or more vertical rods of the rod rail system, moving the nail upward away from the coconut.

In one or more embodiments, the manual coconut opener may include a spring with which to pull back the drill (or the leverage) to its original position, so the user may need to only push the lever downward, and the lever may recover to its original position based on the force of the spring.

The above descriptions are for purposes of illustration and are not meant to be limiting. Numerous other examples, configurations, processes, etc., may exist, some of which are described in greater detail below. Example embodiments will now be described with reference to the accompanying figures.

### Illustrative Processes and Use Cases

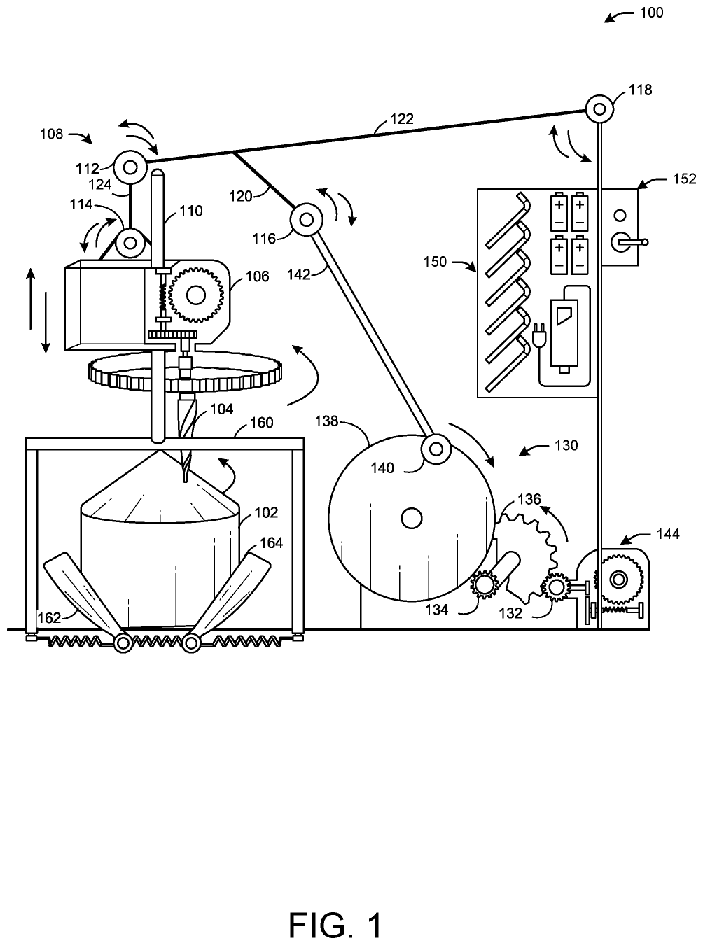

FIG. 1 illustrates an example side view 100 of a schematic of a coconut opening system, in accordance with one or more example embodiments of the present disclosure.

Referring to FIG. 1, the side view 100 shows a coconut 102 arranged in position to be penetrated and opened by a piercing component 104 (e.g., a drill bit). The piercing component 104 may be rotated and controlled by a drill 106 (e.g., to rotate the piercing component 104), and the drill 106 may be part of an adjustable system 108 that may slide up and down vertically along one or more rods 110. The sliding movement of the adjustable system 108 may be caused by rotations about multiple rotating joints (e.g., rotating joint 112, rotating joint 114, rotating joint 116, rotating joint 118). A force applied to a rod 120 may cause a rod 122 to rotate about the rotating joint 112, causing a rod 124 to push or pull the drill 106 via a rotation about the rotating joint 114 (e.g., depending on the direction of the force applied by the rod 120).

Still referring to FIG. 1, the force applied to the rod 120 may depend on a rotating wheel (or gear) system 130 with electrically powered rotating components. For example, a rotating component 132 (e.g., a wheel or gear) may rotate and cause rotation of one or more additional rotating components (e.g., rotating component 134, rotating component 136—gears or wheels), which may cause rotation of one or more additional rotating components (e.g., rotating component 138—a gear or wheel). The rotation of the rotating component 138 may cause movement of a rotating joint 140 that may be operationally connected to the rotating component 138. As the rotating joint 140 moves with the rotating component 138, a rod 142 operatively connected to the rotating joint 140 also may move, causing a push or pull force to the rod 120 via rotation about the rotating joint 116. For example, as the rotating component 138 rotates counterclockwise on the page, the rod 142 may be pushed upward on the page, causing the rod 120 to push the rod 122 to rotate about the rotating joint 112 such that the rod 124 pushes the drill 106 downward, moving the piercing component 104 toward the coconut 102 (e.g., downward on the page). As the rotating component 138 rotates clockwise on the page, the rod 142 may be pulled downward on the page, causing the rod 120 to pull the rod 122 to rotate about the rotating joint 112 such that the rod 124 pulls the drill 106 upward, moving the piercing component 104 away from the coconut 102 (e.g., upward on the page). The rotating components of the rotating wheel system 130 may be rotated by an electrically powered motor 144, which may receive electrical power from an electrical energy source 150 (e.g., a power receptacle or battery). Once the rotating component 138 rotates enough to cause the rotating joint 140 to pull the rod 142 down or push the rod 142 up, the adjustable system 108 may cause the drill 106 to move up or down accordingly (e.g., sliding up or down along the rod 110).

Still referring to FIG. 1, the coconut 102 may be secured by a holding component 160, which may include one or more moveable handlebars (e.g., handlebar 162, handlebar 164) with which to secure and release the coconut 102. In particular, as the piercing component 104 pierces the coconut 102, the handlebar 162 and the handlebar 164 may secure the coconut 102 within the holding component 160.

In one or more embodiments, the rotating joint 112, the rotating joint 114, the rotating joint 116, the rotating joint 118, and/or the rotating joint 140 may include rotary unions and the like.

In one or more embodiments, the rotating component 138 may be larger than the rotating component 134, the rotating component 136, and/or the rotating component 132. For example, the rotating component 138 may have a diameter of 110 mm-130 mm, whereas the rotating component 134, the rotating component 136, and/or the rotating component 132 may have a diameter of 10-30 mm or smaller.

In one or more embodiments, the electrically powered motor 144 may be a worm motor or another kind of motor, and may provide a rotational speed of 40-80 rpm based on an electrical power supply of 12 Volts.

In one or more embodiments, the drill 106 may represent a magnetic electric motor providing 1500-2500 rpm based on a 12 Volt power supply, and providing 2000-3000 rpm based on a 24 Volt power supply. The motor 144 and the drill 106 may receive power from the electrical energy source 150, which may include one or multiple different Voltage supplies (e.g., via wired connections).

In one or more embodiments, operation of the motor 144 and the drill 106 may be controlled by a switch 152. When the switch 152 is in an on position, the motor 144 may rotate and the drill 106 may cause rotation of the piercing component 104. When the switch 152 is in an off position, the motor 144 may stop rotating, and the drill 106 may stop operating. When the motor 144 is active, the rotating component 132 may rotate, causing rotation of the rotating component 136, causing rotation of the rotating component 138.

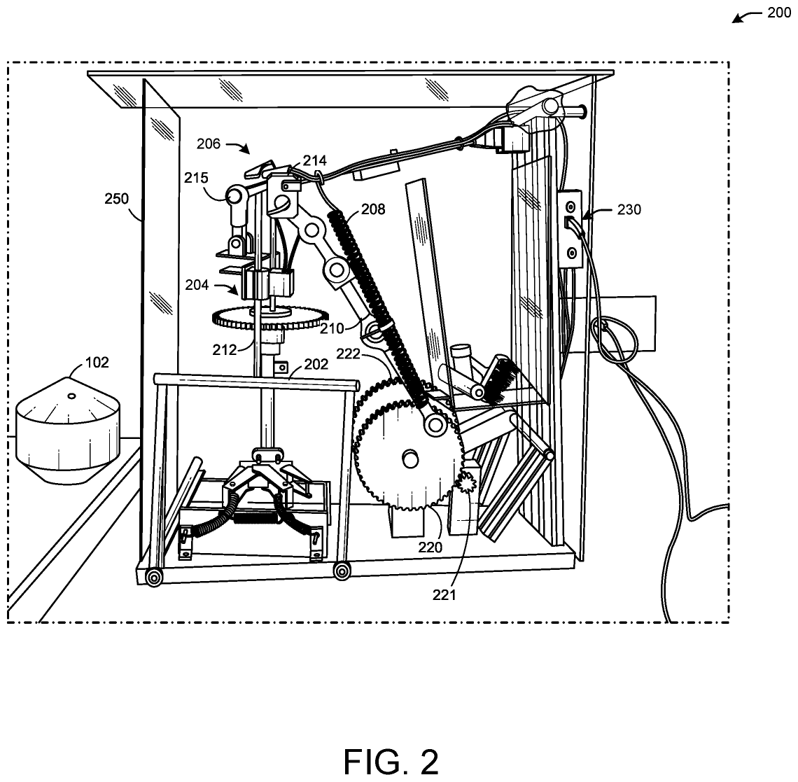

FIG. 2 illustrates an example perspective view 200 of a coconut opening system, in accordance with one or more example embodiments of the present disclosure.

Referring to FIG. 2, the coconut 102 of FIG. 1 is removed from the system, specifically from a holding component 202 (e.g., similar to the holding component 160 of FIG. 1). A drill 204 may be positioned above the holding component 202, and may be moved vertically by an adjustable system 206 (e.g., similar to the adjustable system 108 of FIG. 1). A spring 208 may pull the adjustable system 206. A rod 210 may push and pull the adjustable system 206, causing the adjustable system 206 to slide vertically along a rod 212, causing the drill 204 to move up and down vertically. The adjustable system 206 may include a rotating joint 214 and a rotating joint 215 such that as the rod 210 pushes upward, the adjustable system 206 may move downward vertically due to rotations about the rotating joint 214 and the rotating joint 215, and as the rod 210 pulls downward, the adjustable system 206 may move upward vertically due to rotations about the rotating joint 214 and the rotating joint 215. The rod 210 may push upward or pull downward based on its operative connection to one or more rotating elements 220 (e.g., gears, wheels, etc.). The rotation of the one or more rotating elements 220 may cause the rod 210 to push upward or pull downward. The one or more rotating elements 220 may rotate based on a rotation of additional rotating elements, such as one or more rotating elements 221. Operation of the rotating elements and of the drill 204 may be controlled by electrical power provided by a power supply 230.

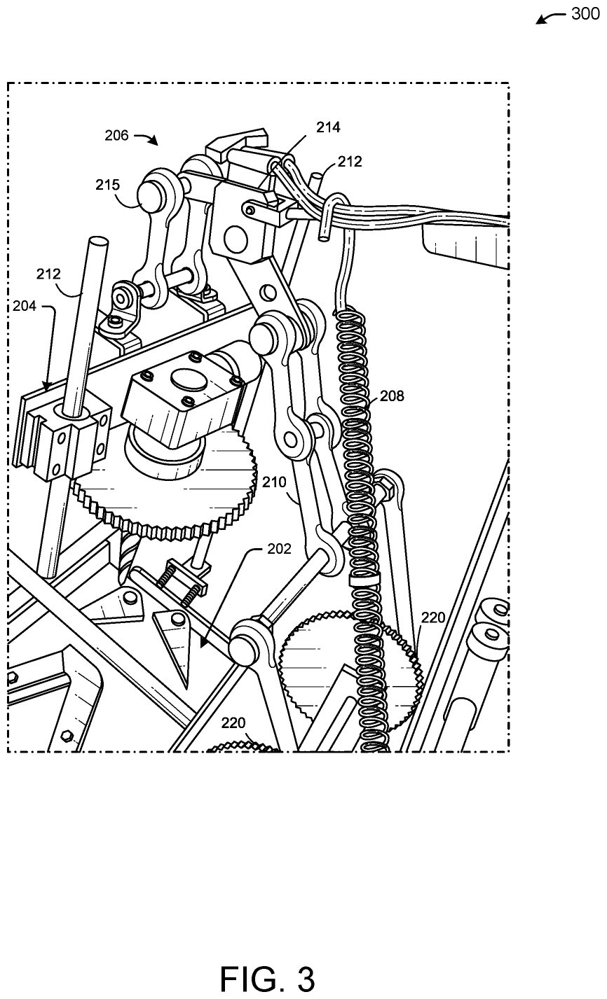

FIG. 3 illustrates an example perspective view 300 of a portion of the coconut opening system of FIG. 2, in accordance with one or more example embodiments of the present disclosure.

Referring to FIG. 3, a portion of the coconut opening system of FIG. 2 is shown in more detail. In particular, the rod 212 may actually represent multiple rods on which the drill 204 may slide vertically above the holding component 202. The one or more rotating elements 220 include two rotating elements that rotate in concert (e.g., a wheel and axel rotation system), causing movement of the rod 210, causing movement of the adjustable system 206 and the drill 204.

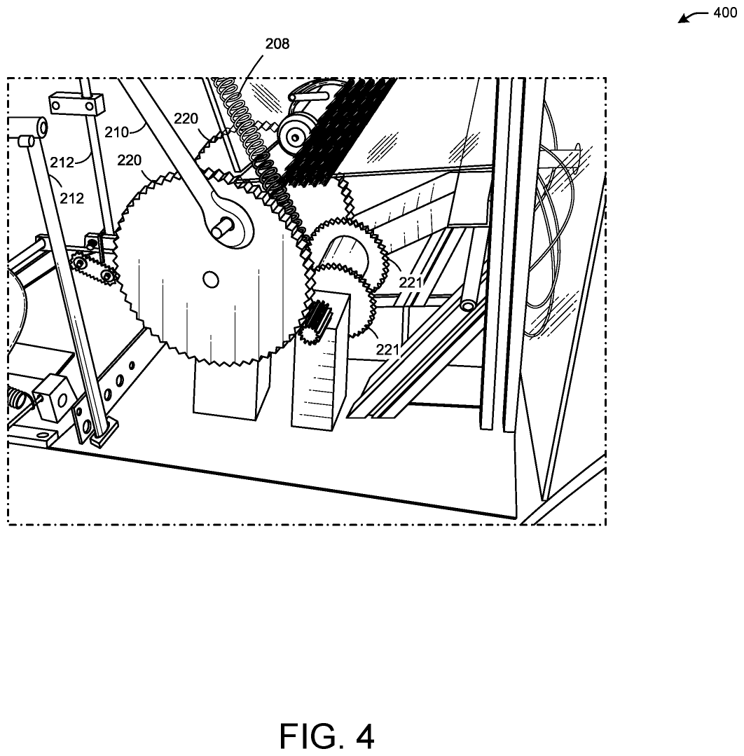

FIG. 4 illustrates an example perspective view of a portion of the coconut opening system of FIG. 2, in accordance with one or more example embodiments of the present disclosure.

Referring to FIG. 4, a portion of the coconut opening system of FIG. 2 is shown in more detail. In particular, the one or more rotating elements 221 include multiple rotating elements (e.g., a wheel and axel system). As the one or more rotating elements 221 rotate, their operative connection (e.g., gear teeth) to the one or more rotating elements 220 (e.g., multiple rotating elements) may cause the one or more rotating elements 220 to rotate, causing movement of the rod 210.

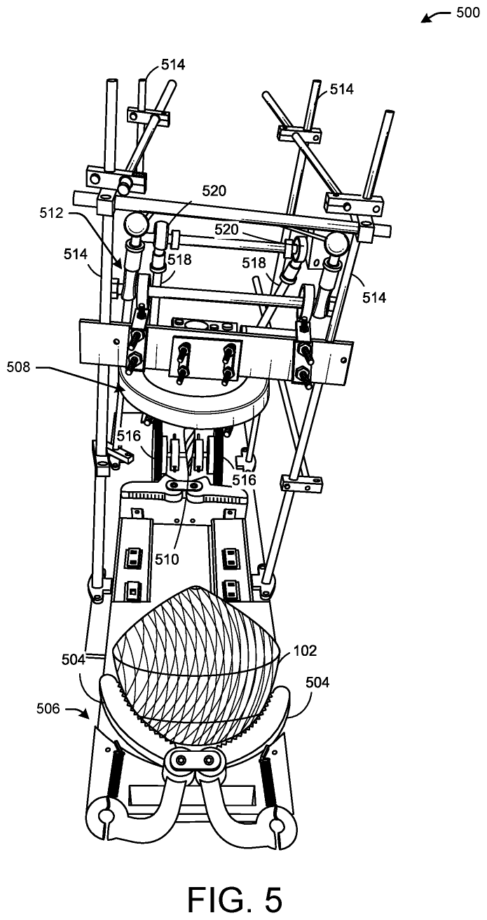

FIG. 5 illustrates an example front view 500 of a coconut opening system, in accordance with one or more example embodiments of the present disclosure.

Referring to FIG. 5, the coconut 102 of FIG. 1 is shown being held by handlebars 504 of a holding system 506. Above the holding system 506 may be a drill 508 with a piercing mechanism 510 (e.g., a drill bit) with which to penetrate the coconut 102. An adjustable system 512 may control vertical movement of the drill 508 about rods 514 (e.g., via sliding). Rotating elements 516 (e.g., gears, wheels) may rotate, causing rods 518 (e.g., operatively connected to the rotating elements 516) to push or pull the adjustable system 512 up or down, depending on the rotation of the rotating elements 516. In particular, as the rods 518 are pushed up or pulled down, rotating joints 520 (e.g., rotary joints/unions, ball and socket joints, etc.) may allow for corresponding movement of the adjustable system 512, which may operatively connect to the rotation joints 520, causing corresponding movement of the drill 508 along the rods 514.

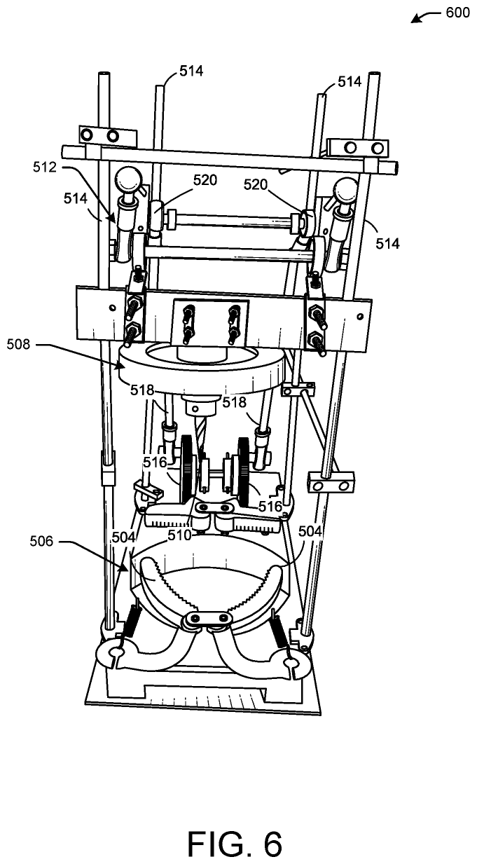

FIG. 6 illustrates an example front view 600 of the coconut opening system of FIG. 5, in accordance with one or more example embodiments of the present disclosure.

Referring to FIG. 6, the operative connection of the rods 518 to the rotating elements 516 is shown. Because of the operation connection of the rods 518 to the rotating elements 516, as the rotating elements 516 rotate, the rods 518 may be pushed up or pulled down, causing rotation at the rotating joints 520, causing corresponding movement of the adjustable system 512 that also may be operative connected to the rotating joints 520 as shown.

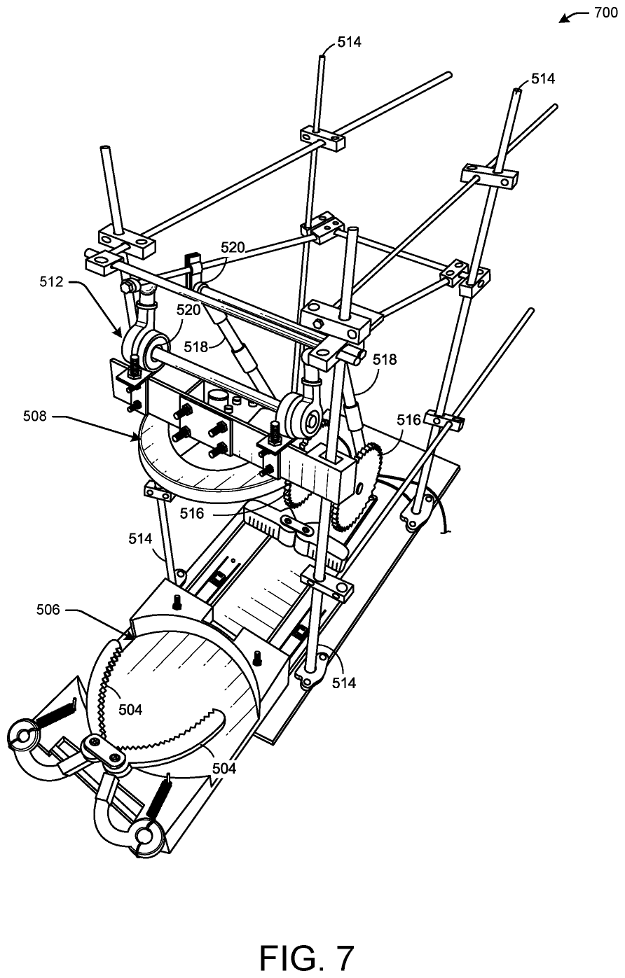

FIG. 7 illustrates an example perspective view 700 of the coconut opening system of FIG. 5, in accordance with one or more example embodiments of the present disclosure.

Referring to FIG. 7, the operative connections of the adjustable system 512 to the rods 514 is shown. As movement of the rods 518 pushes or pulls the adjustable system 512, the adjustable system 512 may slide up or down on the rods 518, causing the drill 508 to move up or down with the adjustable system 512 due to the operative connection of the drill 508 to the adjustable system 512.

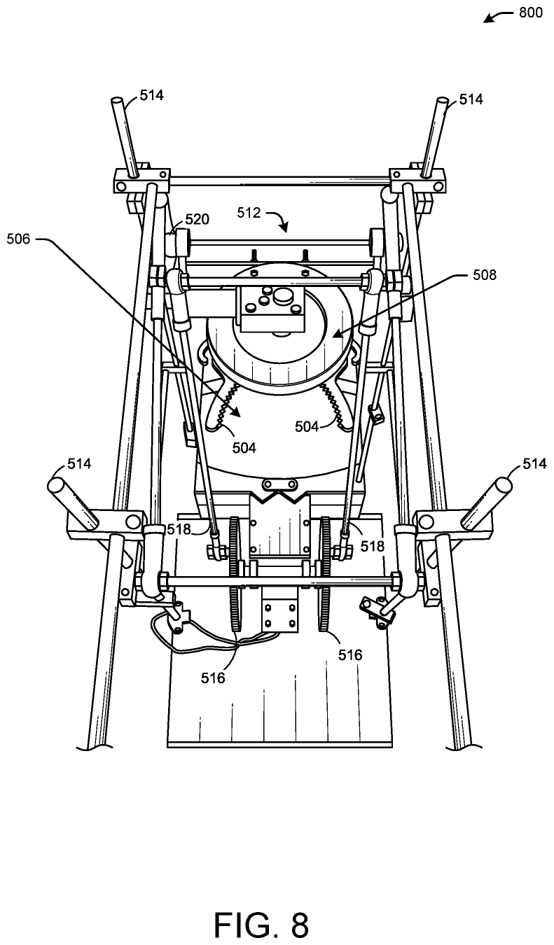

FIG. 8 illustrates an example top view 800 of the coconut opening system of FIG. 5, in accordance with one or more example embodiments of the present disclosure.

Referring to FIG. 8, the operative connection of the rods 518 to the adjustable system 512 is shown, along with the operative connection of the drill 508 to the adjustable system 512. In this manner, when the rotating elements 516 rotate, the rods 518 are pushed up or pulled down, causing rotation about the rotation joints 520, causing movement of the adjustable system 512 operatively connected to the rotation joints 520, causing movement of the drill 508.

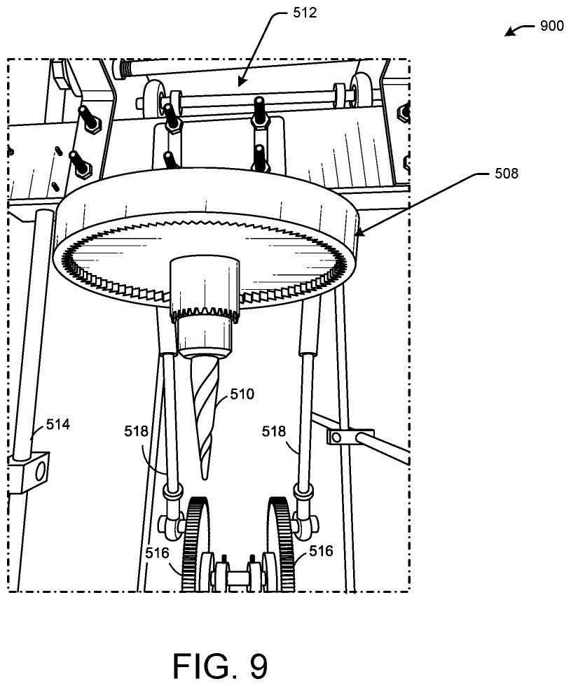

FIG. 9 illustrates an example perspective view 900 of a portion of the coconut opening system of FIG. 5, in accordance with one or more example embodiments of the present disclosure.

Referring to FIG. 9, the drill 508 is shown in detail, along with part of the operative connection of the adjustable system 512 to the rods 518, allowing the adjustable system 512 to slide up and down vertically along the rods 518 to control vertical movement of the drill 508.

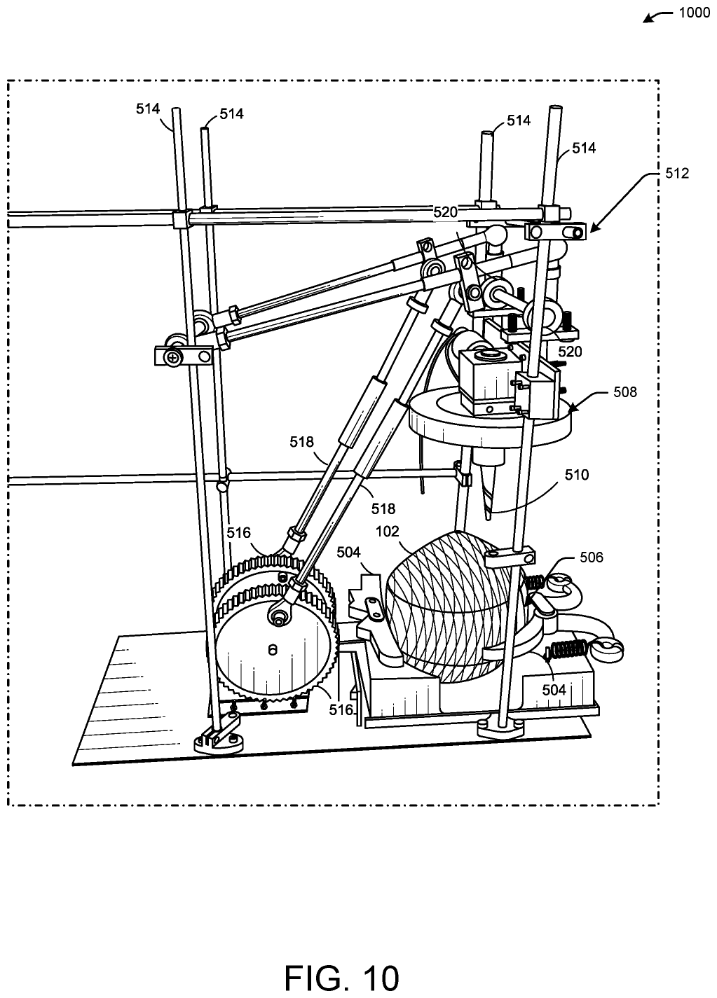

FIG. 10 illustrates an example perspective view 1000 of a portion of the coconut opening system of FIG. 5, in accordance with one or more example embodiments of the present disclosure.

Referring to FIG. 10, the operative connections of the rods 518 to the adjustable system 512 via the rotating joints 520 are shown in detail. As the rods 518 are pushed up or pulled down by rotation of the rotating elements 516, rotation about the rotating joints 520 causes corresponding movement of the adjustable system 512, which moves up and down vertically along the rods 514 as a result.

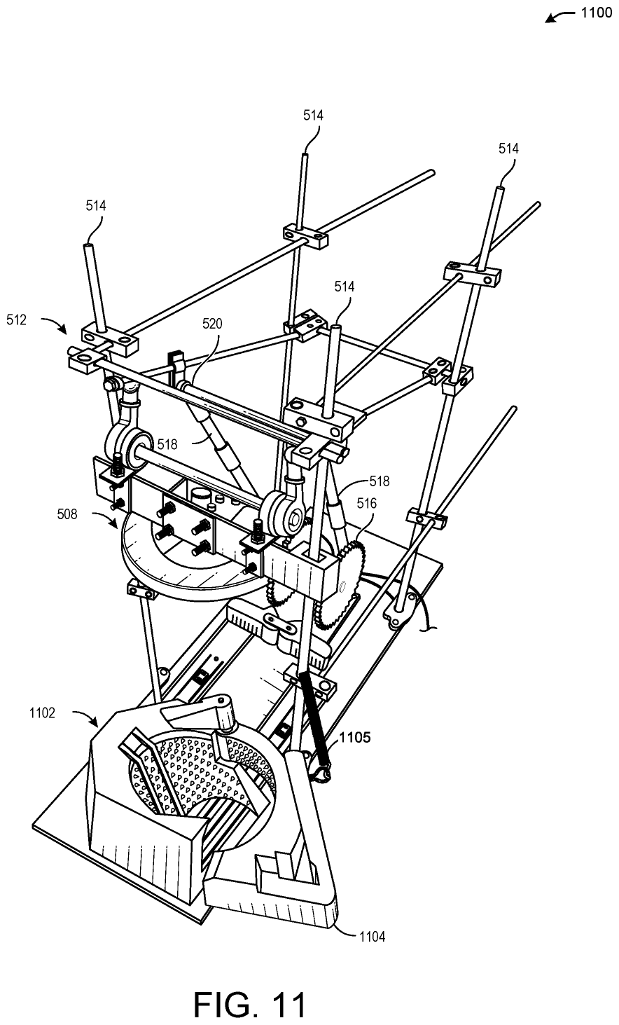

FIG. 11 illustrates an example perspective view 1100 of a portion of the coconut opening system of FIG. 5, in accordance with one or more example embodiments of the present disclosure.

Referring to FIG. 11, the operative connections of the adjustable system 512 to the rods 518 via the rotating joints 520 are shown in detail, along with the sliding connection of the adjustable system 512 to the rods 514. In addition, a holding system 1102 (e.g., for the coconut 102 of FIG. 1) is shown as having a handlebar 1104 in an open position. The handlebar 1104 may rotatably connect to the holding system 1102 to close and secure the coconut 102 of FIG. 1 in the holding system 1102. A spring 1105 may attach to the handlebar 1104 and to one of the rods 514, and may pull the handlebar 1104 away from the holding system 1102 (e.g., opening the holding system 1102) when the holding system 1102 is pulled away (e.g., downward and to the left on the page). When the holding system 1102 is pushed in as shown, the spring 1105 may push in the handlebar 1104 (e.g., a closed position) to secure the coconut 102 of FIG. 1 into the holding system 1102.

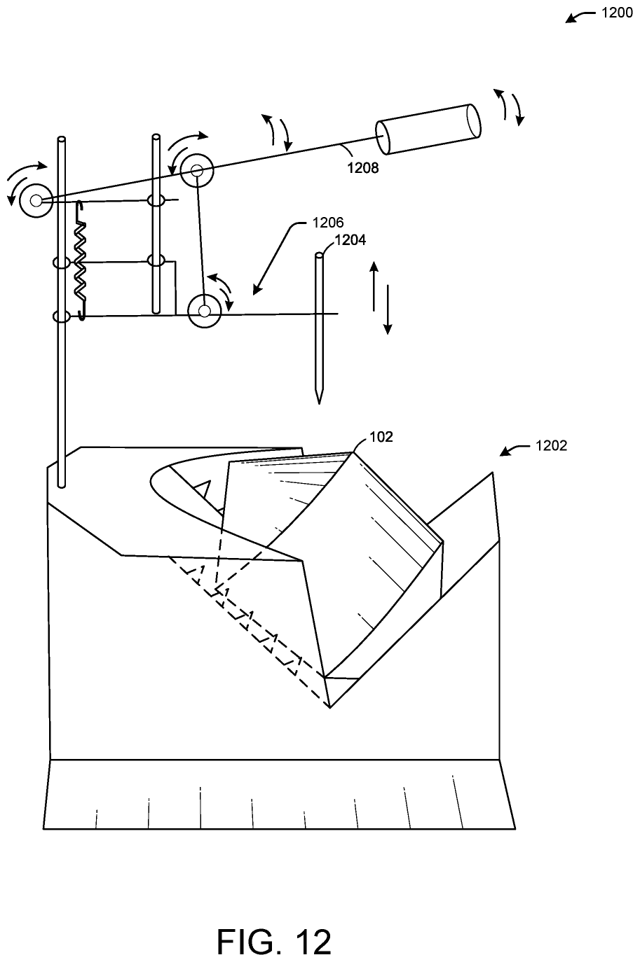

FIG. 12 illustrates an example side view 1200 of a schematic of a coconut opening system, in accordance with one or more example embodiments of the present disclosure.

Referring to FIG. 12, the coconut system shown is a manually operated system. The coconut 102 of FIG. 1 is shown as secured by a holding system 1202. Above the holding system, a piercing component 1204 (e.g., a nail, drill bit, etc.) may be held and operatively controlled by an adjustable system 1206. The adjustable system 1206 may move up and down as described further herein, causing the piercing component 1204 to move up and down toward and away from the coconut 102. The movement of the adjustable system 1206 may be controlled by a manual force applied to a lever 1208. For example, pushing or pulling the lever 1208 downward on the page may cause the adjustable system 1206 and the piercing component 1204 to move downward toward the coconut 102. Pushing or pulling the lever 1208 upward on the page may cause the adjustable system 1206 and the piercing component 1204 to move upward away from the coconut 102.

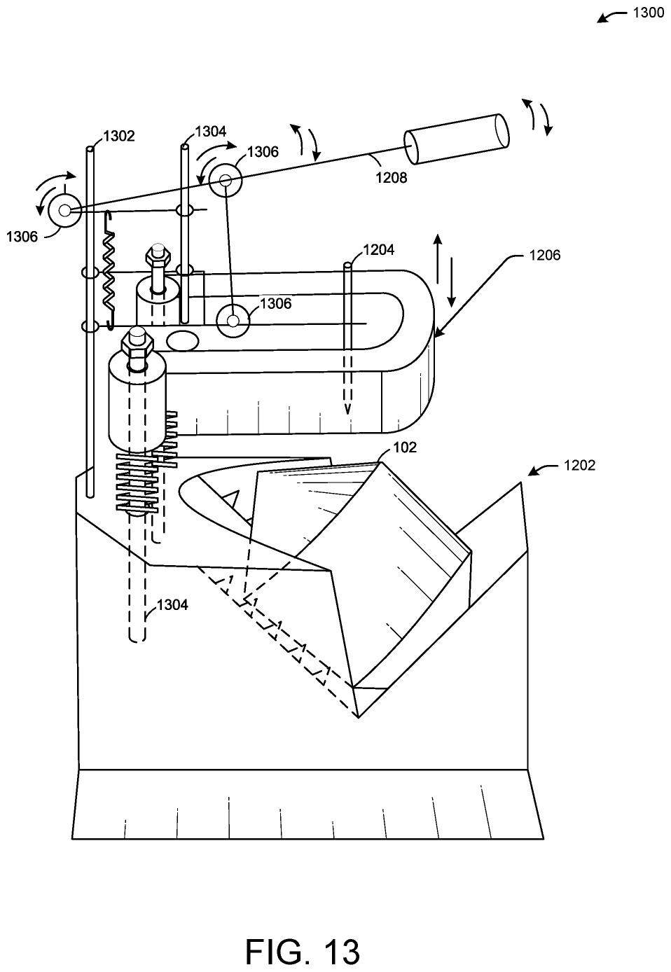

FIG. 13 illustrates an example side view 1300 of the coconut opening system of FIG. 12, in accordance with one or more example embodiments of the present disclosure.

Referring to FIG. 13, the adjustable system 1206 of FIG. 12 is shown in more detail. In particular, the adjustable system 1206 may slide vertically along vertical rod 1302 and along vertical rods 1304 based on the movement of, and corresponding force of, the lever 1208. As the lever 1208 is pushed or pulled up or down, the lever may cause rotation about rotating joints 1306 (e.g., rotatable joints/unions, ball and socket joints, etc.) to which the adjustable system 1206 may be operatively connected, thereby causing movement of the adjustable system 1206 up or down vertically.

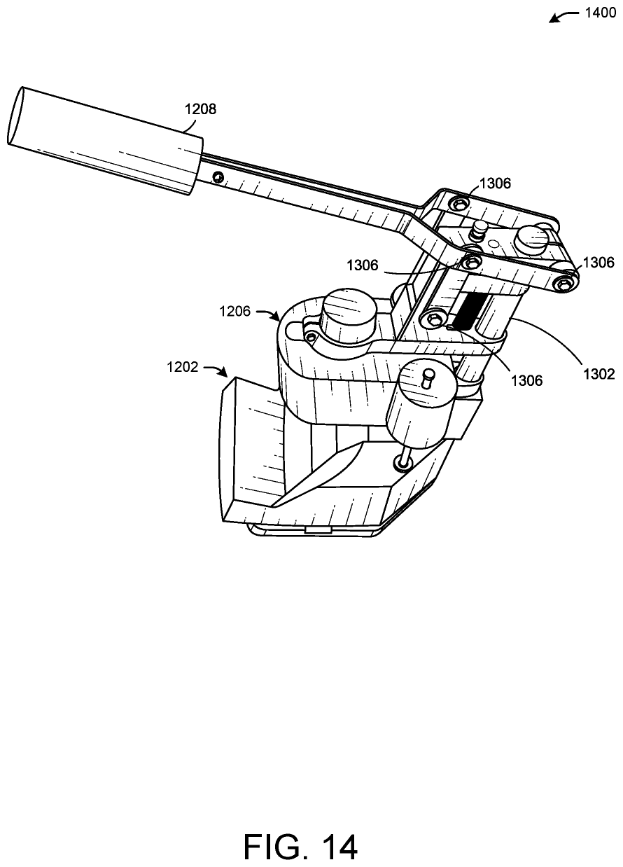

FIG. 14 illustrates an example perspective view 1400 of the coconut opening system of FIG. 12, in accordance with one or more example embodiments of the present disclosure.

Referring to FIG. 14, the lever 1208 of FIG. 12 is shown in more detail, including its operative connections to the rotating joints 1306.

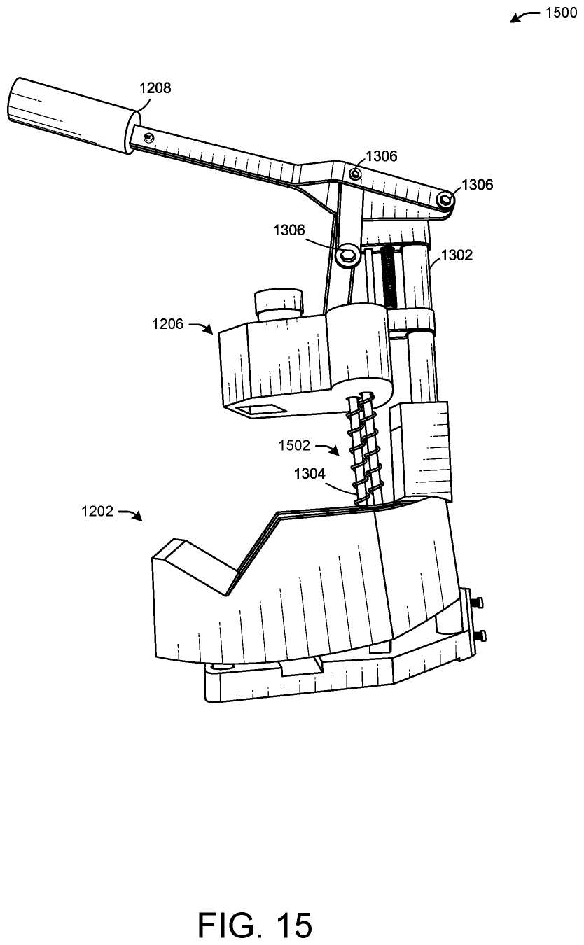

FIG. 15 illustrates an example side view 1500 of the coconut opening system of FIG. 12, in accordance with one or more example embodiments of the present disclosure.

Referring to FIG. 15, the operative connection of the adjustable system 1206 of FIG. 12 to the lever 1208 via the rotating joints 1306 is shown. Also, springs 1502 may wrap around the vertical rods 1304, causing an upward force to be applied to the adjustable system 1206 as the adjustable system 1206 moves downward toward the coconut 102 of FIG. 1 (e.g., when secured in the holding system 1202).

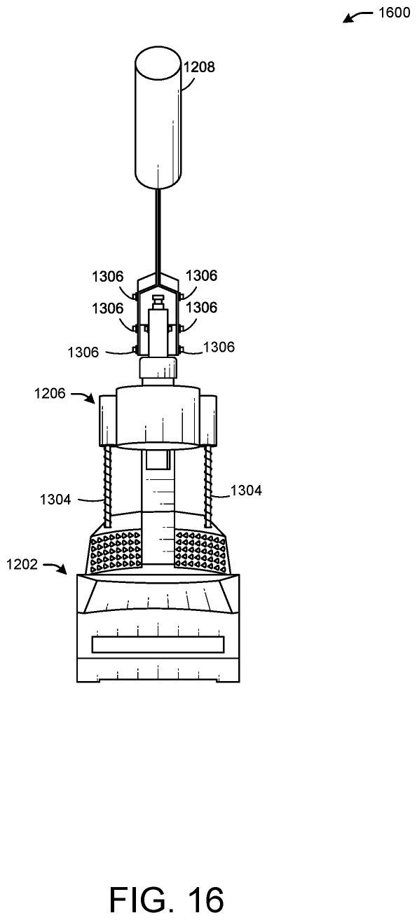

FIG. 16 illustrates an example front view 1600 of the coconut opening system of FIG. 12, in accordance with one or more example embodiments of the present disclosure.

Referring to FIG. 16, the vertical rods 1304 and the holding system 1202 are shown in detail, along with the rotating joints 1306 and their operative connections to the lever 1208 and to the adjustable system 1206.

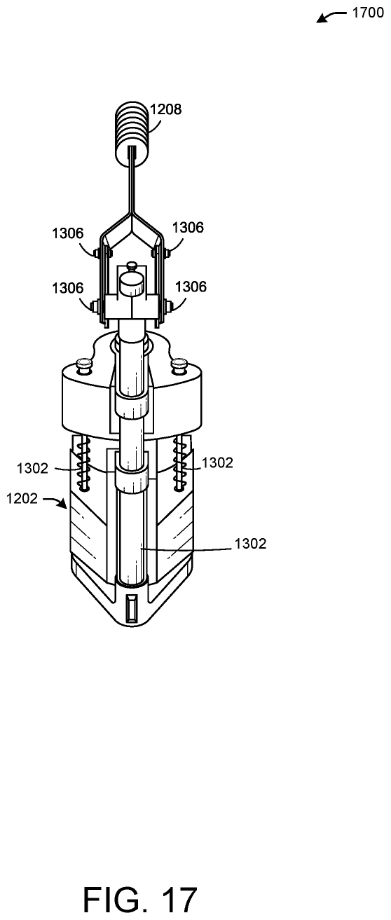

FIG. 17 illustrates an example rear view 1700 of the coconut opening system of FIG. 12, in accordance with one or more example embodiments of the present disclosure.

Referring to FIG. 17, the slidable connections of the adjustable system 1206 to the vertical rods 1302 are shown in detail, along with the rotating joints 1306 and their operative connections to the lever 1208 and to the adjustable system 1206.

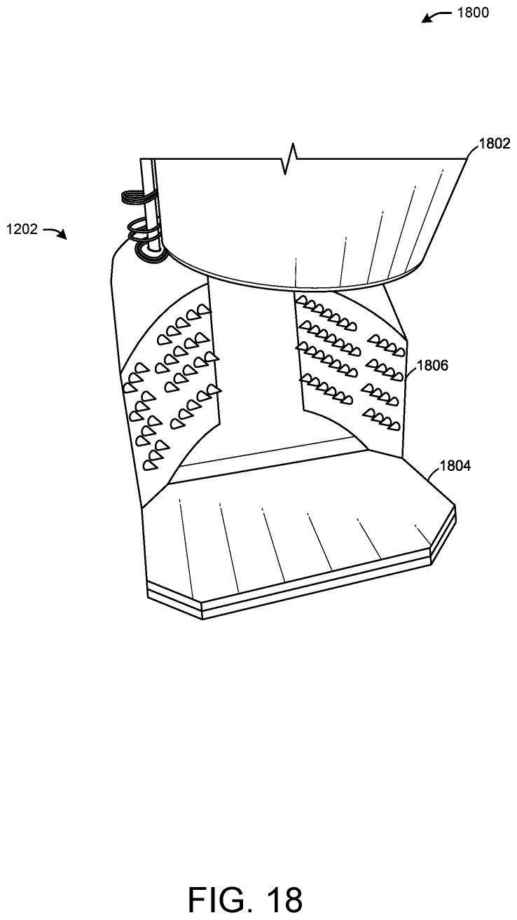

FIG. 18 illustrates an example front view 1800 of a portion of the coconut opening system of FIG. 12, in accordance with one or more example embodiments of the present disclosure.

Referring to FIG. 18, the holding system 1202 may include a flexible component 1802 that may secure the coconut 102 in the holding system 1202 while the piercing component 1204 of FIG. 12 is being removed from the coconut 102 (e.g., after piercing). The holding system 1202 also may include a bottom portion 1804 on which the coconut 102 may be positioned while within the holding system 1202. The bottom portion 1804 may be removable from the holding system 1202.

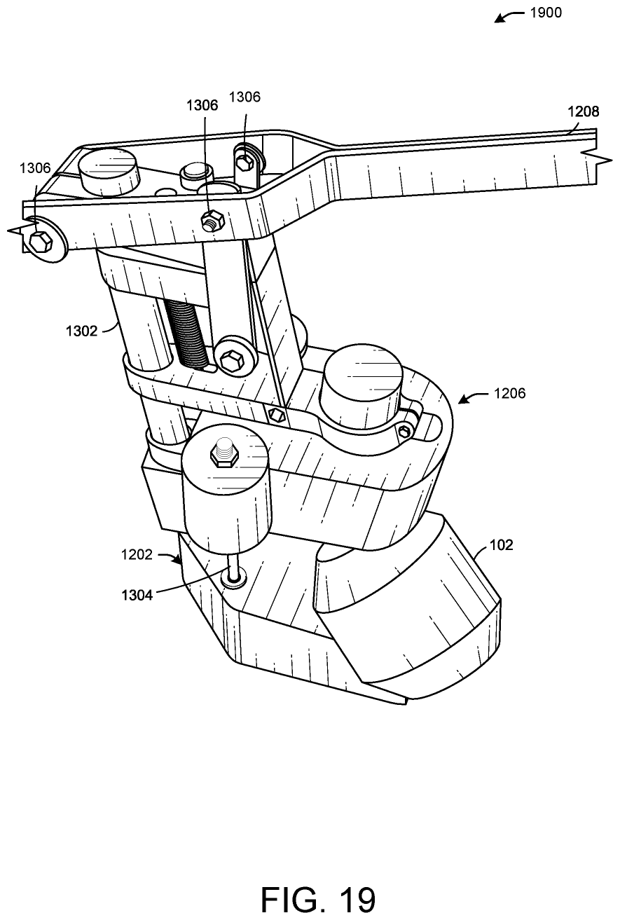

FIG. 19 illustrates an example perspective view 1900 of the coconut opening system of FIG. 12, in accordance with one or more example embodiments of the present disclosure.

Referring to FIG. 19, the coconut 102 is shown as secured within the holding system 1202. The operative connections of the lever 1208 and the adjustable system 1206 to the rotating joints 1306 are shown.

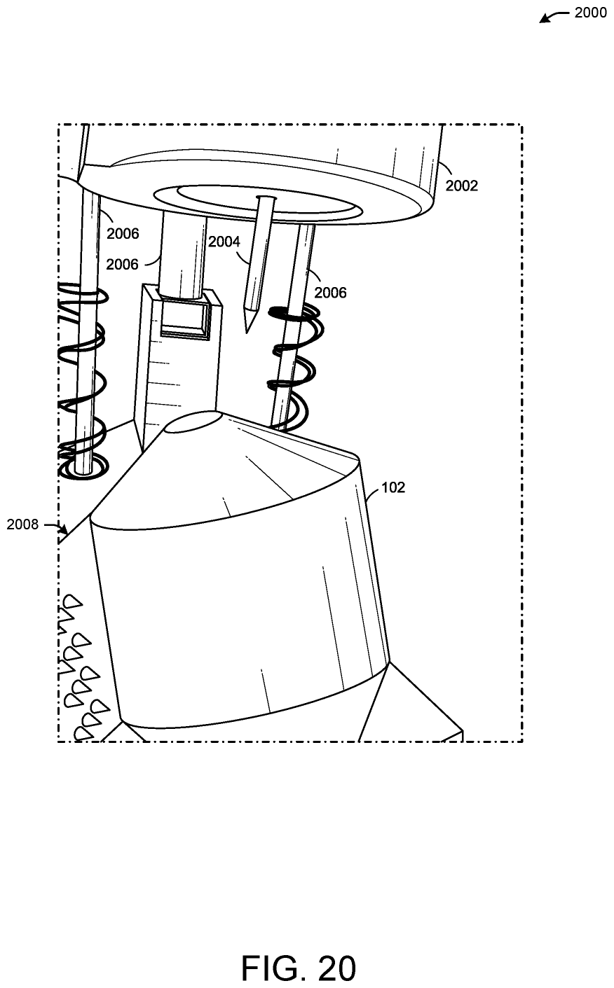

FIG. 20 illustrates an example front view 2000 of a portion of the coconut opening system of FIG. 12, in accordance with one or more example embodiments of the present disclosure.

Referring to FIG. 20, an adjustable system 2002 (e.g., representing the adjustable system 1206 of FIG. 12) may secure a piercing element 2004 (e.g., representing the piercing component 1204 of FIG. 12). The adjustable system 2002 may slide vertically along rods 2006 (e.g., representing the vertical rod 1302 and the vertical rods 1304 of FIG. 13) to move the piercing element 2004 toward or away from the coconut 102 while secured in a holding system 2008.

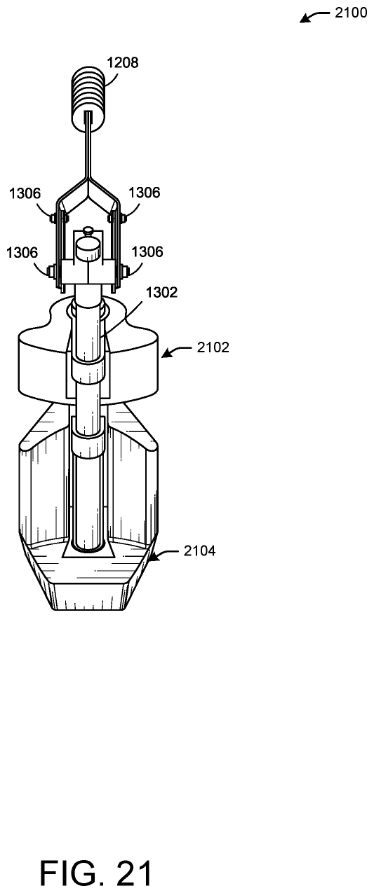

FIG. 21 illustrates an example front view 2100 of the coconut opening system of FIG. 12, in accordance with one or more example embodiments of the present disclosure.

Referring to FIG. 21, an adjustable system 2102 may represent a variation of the adjustable system 1206 of FIG. 12, and a holding system 2104 (e.g., to secure the coconut 102 of FIG. 1) may represent a variation of the holding system 1202 of FIG. 12.

The embodiments described herein are not meant to be limiting.

The word “exemplary” is used herein to mean “serving as an example, instance, or illustration.” Any embodiment described herein as “exemplary” is not necessarily to be construed as preferred or advantageous over other embodiments.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The processes described and shown above may be carried out or performed in any suitable order as desired in various implementations. Additionally, in certain implementations, at least a portion of the processes may be carried out in parallel, creating a co-existence use case. Furthermore, in certain implementations, less than or more than the processes described may be performed.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims.

What is claimed is:

1. A device for opening coconuts, the device comprising:
a piercing component configured to pierce a coconut;
an adjustable component configured to move the piercing component vertically with respect to the ground toward and away from a coconut based on a received user input; and
a coconut holding component arranged below the piercing component and configured to secure the coconut while the coconut is pierced by the piercing component.

2. The device of claim 1, further comprising:
an electrically powered rotating component configured to rotate the piercing component,
wherein the electrically powered rotating component is operatively connected to the adjustable component.

3. The device of claim 1, further comprising:
one or more motors operatively connected to the adjustable component and configured to move the piercing component vertically toward and away from a coconut based on the received user input,
wherein the received user input comprises an input associated with controlling a rotational direction of the one or more motors.

4. The device of claim 1, wherein the adjustable component comprises a wheel and an axel associated with providing torque to the piercing component.

5. The device of claim 1, wherein the coconut holding component comprises a moveable handlebar associated with securing the coconut.

6. The device of claim 1, wherein the coconut holding component comprises a flexible component associated with securing the coconut while the piercing component is removed from the coconut.

7. The device of claim 1, wherein the adjustable component comprises an elastic component associated with moving the piercing component away from the coconut.

8. The device of claim 1, wherein the received user input is a force applied manually to the adjustable component by a user.

9. The device of claim 8, wherein the force is applied using a lever operatively connected to the adjustable component, and wherein the force causes the adjustable component to move the piercing component vertically toward or away from the coconut.

10. The device of claim 1, wherein the adjustable component is configured to slide along one or more rods arranged vertically with respect to the ground.

11. A system for opening coconuts, the system comprising:
a piercing component configured to pierce a coconut;
an adjustable component configured to move the piercing component vertically with respect to the ground toward and away from a coconut based on a received user input;
a rotating component configured to rotate the piercing component; and
a coconut holding component arranged below the piercing component and configured to secure the coconut while the coconut is pierced by the piercing component.

12. The system of claim 11, wherein the rotating component is operatively connected to the adjustable component.

13. The system of claim 11, further comprising:
one or more motors operatively connected to the adjustable component and configured to move the piercing component vertically toward and away from a coconut based on the received user input,
wherein the received user input comprises an input associated with controlling a rotational direction of the one or more motors.

14. The system of claim 11, wherein the adjustable component comprises a wheel and an axel associated with providing torque to the piercing component.

15. The system of claim 11, wherein the coconut holding component comprises a moveable handlebar associated with securing the coconut.

16. The system of claim 11, wherein the coconut holding component comprises a flexible component associated with securing the coconut while the piercing component is removed from the coconut.

17. The system of claim 11, wherein the adjustable component comprises an elastic component associated with moving the piercing component away from the coconut.

18. A system for opening coconuts, the system comprising:
a piercing component configured to pierce a coconut;
an adjustable component configured to move the piercing component vertically with respect to the ground toward and away from a coconut based on a received user input;
a lever operatively connected to the adjustable component and configured to receive the received user input; and
a coconut holding component arranged below the piercing component and configured to secure the coconut while the coconut is pierced by the piercing component.

19. The system of claim 18, wherein the received user input is a force applied manually to the lever.

20. The device of claim 1, wherein the adjustable component is configured to slide along one or more rods arranged vertically with respect to the ground.
